(19) United States
(12) Patent Application Publication
(10) Pub. No.: US 2024/0161395 A1
(43) Pub. Date: May 16, 2024

(54) METHODS AND SYSTEMS FOR FORMING THREE-DIIMENSIONAL 3D MODELS OF OBJECTS

(71) Applicants: Nikon Corporation, Tokyo (JP); The Curators of the University of Missouri, Columbia, MO (US)

(72) Inventors: Chuanmao Fan, San Jose, CA (US); Ye Duan, Clayton, MO (US); Bausan Yuan, San Jose, CA (US)

(73) Assignees: Nikon Corporation, Tokyo (JP); The Curators of the University of Missouri, Columbia, MO (US)

(21) Appl. No.: 18/505,106

(22) Filed: Nov. 8, 2023

Related U.S. Application Data
(60) Provisional application No. 63/424,391, filed on Nov. 10, 2022.

(51) Int. Cl. G06T 17/00; G06V 10/44; G06V 10/82

(52) U.S. Cl. CPC G06T 17/00; G06V 10/44; G06V 10/82

(57) ABSTRACT

Methods and systems for generating 3D models of surfaces that accurately reconstruct both the global structure of an object and its local features are described. The methods and systems generally operated by fusing point features from the point cloud data with voxel features extracted from voxelization procedures. Furthermore, the methods and systems utilize voxelization at multiple spatial resolutions. The use of point-voxel fusion and multiple spatial resolutions may permit the extraction of both global and local geometric features, increasing the accuracy of 3D modeling of objects.

### CROSS-REFERENCE

This application claims priority to U.S. Provisional Application No. 63/424,391, filed on Nov. 10, 2022, entitled “POINT VOXEL FEATURE FUSION FOR IMPLICIT FIELD OF 3D RECONSTRUCTION,” which is incorporated herein by reference in its entirety for all purposes.

### TECHNICAL FIELD

The disclosed embodiments generally relate to forming 3D models of objects based on point cloud data associated with the objects.

### BACKGROUND

3D surface reconstruction is important for many applications, including augmented reality, virtual production, and autonomous driving, among others. There are numerous approaches to 3D surface reconstruction methods, including image based 3D reconstruction, multi-view based 3D reconstruction, and point cloud based 3D reconstruction. Of these, point cloud based 3D reconstruction methods may be the most ubiquitous due to the availability of a wide range of affordable hardware (such as 3D scanners and laser distance and ranging (LIDAR) scanners, among others) which perform surface measurements and output point cloud data. Such point cloud data generally comprises a series of coordinates associated with points located on or near the surface of an object that is measured using 3D scanning hardware. The goal of point cloud based 3D reconstruction methods is to output a surface model defining the scanned object using the point cloud data.

Recent work on point cloud based 3D reconstruction has largely focused on 3D deep learning procedures. Deep learning based methods are the go to choice for point cloud data that is sparse, noisy, or incomplete. Such sparsity, noisiness, or incompleteness is common in point cloud data. Unfortunately, previous 3D deep learning procedures suffer from a variety of drawbacks. For instance, some 3D deep learning procedures are only capable of outputting surface models with limited spatial resolution. Other 3D deep learning procedures suffer from discretization errors that reduce the accuracy of the surface model. Still other 3D deep learning procedures can only be used to output surface models for a narrow and limited class of objects (e.g., objects that are similar to the training set used to train the 3D deep learning procedure). As such, previous 3D deep learning procedures are often incapable of outputting accurate surface models for a wide range of objects.

### SUMMARY

Methods and systems for generating 3D models of surfaces that accurately reconstruct both the global structure of an object and its local features are described. The methods and systems generally operated by fusing point features from the point cloud data with voxel features extracted from voxelization procedures. Furthermore, the methods and systems utilize voxelization at multiple spatial resolutions. The use of point-voxel fusion and multiple spatial resolutions may permit the extraction of both global and local geometric features, increasing the accuracy of 3D modeling of objects.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 depicts an exemplary method for forming a 3D model of an object, in accordance with various embodiments.

FIG. 2 depicts a first exemplary instantiation of the method described herein with respect to FIG. 1, in accordance with various embodiments.

FIG. 3 depicts a second exemplary instantiation of the method described herein with respect to FIG. 1, in accordance with various embodiments.

FIG. 4 depicts a block diagram of a computer system used to perform all or portions of the methods described herein with respect to FIG. 1, in accordance with various embodiments.

FIG. 5 depicts exemplary 3D model reconstructions of an automobile obtained using a variety of 3D model reconstruction methods, in accordance with various embodiments.

FIG. 6 depicts exemplary 3D model reconstructions of representative shapes from all classes of the shapenet dataset obtained using a variety of 3D model reconstruction methods, in accordance with various embodiments.

FIG. 7 depicts exemplary 3D model reconstructions of garments obtained using a variety of 3D model reconstruction methods, in accordance with various embodiments.

FIG. 8 depicts exemplary 3D model reconstructions of human bodies obtained using a variety of 3D model reconstruction methods, in accordance with various embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

3D surface reconstruction is important for many applications, including augmented reality, virtual production, and autonomous driving, among others. There are numerous approaches to 3D surface reconstruction methods, including image based 3D reconstruction, multi-view based 3D reconstruction, and point cloud based 3D reconstruction. Of these, point cloud based 3D reconstruction methods may be the most ubiquitous due to the availability of a wide range of affordable hardware (such as 3D scanners and laser distance and ranging (LIDAR) scanners, among others) which perform surface measurements and output point cloud data. Such point cloud data generally comprises a series of coordinates associated with points located on or near the surface of an object that is measured using 3D scanning hardware. The goal of point cloud based 3D reconstruction methods is to output a surface model defining the scanned object using the point cloud data.

Recent work on point cloud based 3D reconstruction has largely focused on 3D deep learning procedures. Deep learning based methods are the go to choice for point cloud data that is sparse, noisy, or incomplete. Such sparsity, noisiness, or incompleteness is common in point cloud data. Among the most promising approaches to deep learning methods for point cloud based 3D reconstruction are a variety of approaches that use neural implicit 3D modeling (also referred to herein as “implicit representation”) with latent codes (also referred to herein as “feature vectors”).

Implicit representation generally operates by obtaining a latent code through encoding networks, concatenating the latent code with the coordinates of a point in the point cloud data (referred to as a “query point”), and passing the concatenated data to a machine learning procedure such as a neural network (NN), convolutional NN (CNN), 3D CNN, or multi-layer perceptron (MLP). The neural network then outputs a value indicating whether the query point is inside (negative distance) or outside (positive distance) of a model surface representing an object. AtlasNet (described in T. Groueix et al, “AtlasNet: a papier-mache approach to learning 3D surface generation,” arXiv:1802.05384, 2018), DeepSDF (described in J. J. Park et al, “DeepSDF: learning continuous signed distance functions for shape representation,” arXiv:109.05103, 2019), occupancy networks (described in L. Mescheder et al, “Occupancy networks: learning 3D reconstruction in function space,” arXiv:1812.03828, 2018), and IF-Net (described in Z. Chen and H. Zhang, “Learning implicit fields for generative shape modeling,” arXiv:1812.02822, 2018) are among the earliest methods for using deep learning to learn neural implicit representations for 3D modeling. Unfortunately, the outputs of such models are generally constrained to narrow classes of surfaces that fall within the class of surfaces from the training data used to train the models. Thus, such approaches are typically unable to output 3D surface models for most classes of objects.

One possible reason why pioneering works like deepSDF, occupancy networks, IF-Net, and the like are not able to produce satisfying 3D models for large classes of objects is due to their reliance on encoding the whole input to a single latent code. Unfortunately, the use of a single latent code, while good at encoding large-scale geometric features, is quite poor at encoding local geometric details. Points2surf (described in P. Erler et al, “Points2Surf: learning implicit surfaces from point cloud patches,” arXiv:2007.10453, 2020) tried to generalize the network modeling capabilities of SDF by combining local features (which provide unsigned distances of the points in the point cloud data) and large range neighbor features (which provide the sign, i.e., whether a given point is inside or outside of surface). IF-Net (described in P.-H. Chen et al, “IF-Net: an illumination-invariant feature network,” arXiv:2008.03897, 2020) and NDF (described in J. Chibane et al, “Neural distance fields for implicit function learning,” arXiv:2010.13938, 2020) further extend these ideas. Instead of encoding surfaces with a single vector, they encode multiple levels of rich features by 3D convolution on a grid of discrete volume.

A majority of current approaches to deep learning based 3D reconstruction methods classify points as inside or outside of a surface by occupancy indicator or associate a signed distance to the surface with each point. Unfortunately, such representations can only be applied to closed surfaces. Many 3D objects such as clothes, cars, surface of thin sheet, or partial scans of a shape, and the like should be represented as open surface. Thus, methods such as NDF learn an implicit unsigned distance field, allowing the reconstruction of sharp edges of open surfaces and the like.

All previous approaches for generating 3D models from point cloud data either utilize the point cloud directly or voxelize the point cloud data into discrete volumes (also referred to as “voxels”). Using the point cloud data directly is light weight but often lacks information about local neighbor features. Volume based approaches require voxelization of points into discrete 3D volumes (a process referred to as “voxelization”). Such approaches include more local neighbor information but require substantial memory resources, as the memory requirements increase cubically with spatial resolution. For instance, a spatial resolution of 128\hat{ }3 (i.e., dividing the volume into 128\hat{ }3 voxels) requires 8 times as much memory as a spatial resolution of 64\hat{ }3. Such voxelization of points leads to decreases in accuracy owing to this discretization. Moreover, such techniques often require tradeoffs in accuracy between local structures and global features. That is, techniques that utilize high spatial resolution are often capable of accurately reconstructing local features but struggle to accurately reproduce the global structure of the model surface. Techniques that utilize low spatial resolution are often capable of accurately reconstructing the global structure of the model surface but struggle to capture local features. Thus, there is a need for methods and systems that generate 3D models of surfaces that accurately reconstruct both the global structure of an object and its local features.

The methods and systems disclosed herein generate 3D models of surfaces that accurately reconstruct both the global structure of an object and its local features. The methods and systems generally operated by fusing point features from the point cloud data with voxel features extracted from voxelization procedures. Furthermore, the methods and systems utilize voxelization at multiple spatial resolutions. The use of point-voxel fusion and multiple spatial resolutions may permit the extraction of both global and local geometric features, increasing the accuracy of 3D modeling of objects.

As used herein, unless specifically stated otherwise, the terms “a” and “an” mean “one or more,” except where infeasible. Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, both conjunctive and disjunctive, except where infeasible. For example, if it is stated that a component may include A or B, then, unless specifically stated otherwise or infeasible, the component may include A alone, or B alone, or A and B. As a second example, if it is stated that a component may include A, B, or C, then, unless specifically stated otherwise or infeasible, the component may include A alone, or B alone, or C alone, or A and B, or A and C, or B and C, or A and B and C.

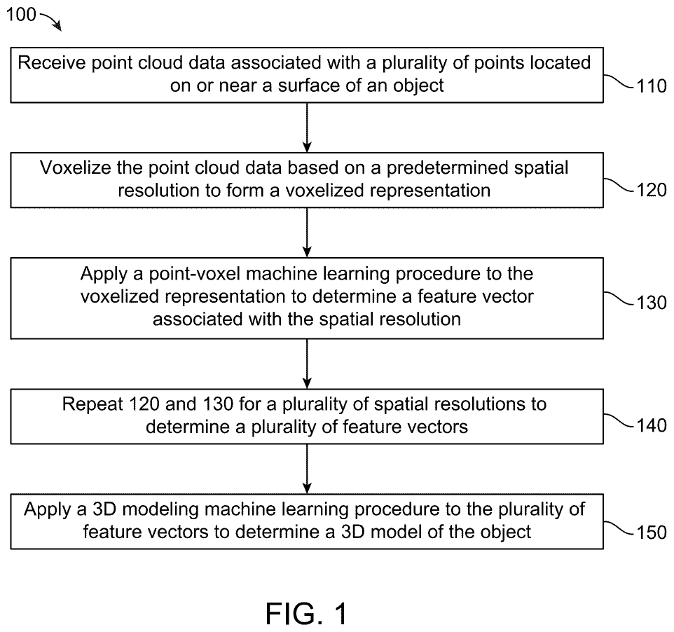

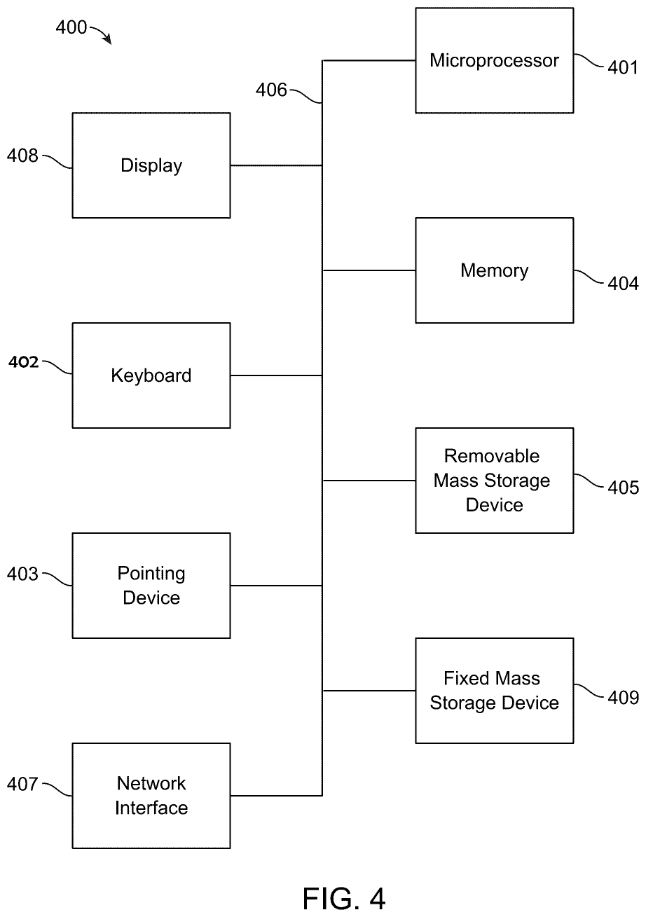

FIG. 1 depicts an exemplary method 100 for forming a 3D model of an object. In some embodiments, the method 100 is performed using a computing system, such as computing system 400 described herein with respect to FIG. 4.

At step 110, point cloud data is received. In some embodiments, the point cloud data comprises a series of coordinates associated with a plurality of points located on or near a surface of the object. That is, in some embodiments, the point cloud data comprises a series of coordinates {(x₁,y₁,z₁), (x₂,y₂,z₂), . . . }, where (x₁,y₁,z₁) is the Cartesian coordinates of the first point in the point cloud data, (x₂,y₂,z₂) is the Cartesian coordinates of the second point in the point cloud data, and so forth. In some embodiments, the point cloud data is obtained using a 3D scanner, tomographic imaging scanner, LIDAR scanner, or any other scanner that outputs point cloud data associated with the surface.

At step 120, the point cloud data is voxelized. In some embodiments, the point cloud data is voxelized based on a predetermined spatial resolution. For instance, in some embodiments, the point cloud data is voxelized based on a spatial resolution of 16\hat{ }3, 32\hat{ }3, 64\hat{ }3, 128\hat{ }3, 256\hat{ }3, 512\hat{ }3, 1024\hat{ }3, or the like. That is, in some embodiments, the point cloud data is voxelized into 16\hat{ }3, 32\hat{ }3, 64\hat{ }3, 128\hat{ }3, 256\hat{ }3, 512\hat{ }3, 1024\hat{ }3, or the like voxels. In some embodiments, each of the voxels has a volume of V/16\hat{ }3, V/32\hat{ }3, V/64\hat{ }3, V/128\hat{ }3, V/256\hat{ }3, V/512\hat{ }3, V/1024\hat{ }3, or so forth, where V is the volume occupied by the point cloud data. In some embodiments, the point cloud data is voxelized based on an occupancy procedure. That is, in some embodiments, each voxel is given a value of 1 if one or more points from the point cloud data are located in that voxel and a value of 0 if no points from the point cloud data are located in that voxel. In other embodiments, the point cloud data is voxelized based on a pointgrid procedure (described in T. Len and Y. Duan, “PointGrid: a deep network for 3D space understanding,” IEEE/CVF Conference on Computer Vision and Pattern Recognition, 2018, doi :10.1109/CVPR.2018.00959, which is incorporated herein by reference in its entirety for all purposes). In some embodiments, voxelizing the point cloud data forms a voxelized representation of the point cloud data.

At step 130, a point-voxel machine learning procedure is applied to the voxelized representation of the point cloud data and/or the point cloud data. In some embodiments, the point-voxel machine learning procedure comprises a NN, CNN, 3D CNN, or MLP. In some embodiments, the point-voxel machine learning procedure comprises a neural implicit representation procedure (described in J. Chibane et al, “Neural distance fields for implicit function learning,” arXiv:2010.13938, 2020, which is incorporated herein by reference in its entirety for all purposes). In some embodiments, the point-voxel machine learning procedure determines or outputs a feature vector Fₖ associated with the predetermined spatial resolution from step 120.

At step 140, steps 120 and 130 are repeated for a plurality of spatial resolutions. In some embodiments, each repetition of steps 120 and 130 outputs a feature vector Fₖ, where k ∈ {1, 2, . . . , n} and n is the number of times steps 120 and 130 are repeated. Thus, in some embodiments, a plurality of feature vectors are determined and each feature vector is associated with a spatial resolution. In some embodiments, n is at least 2, 3, 4, 5, 6, 7, 8, 9, 10, 11, 12, 13, 14, 15, 16, 17, 18, 19, 20, or more, at most 20, 19, 18, 17, 16, 15, 14, 13, 12, 11, 10, 9, 8, 7, 6, 5, 4, 3, or 2, or within a range defined by any two of the preceding values. As a first example, in some embodiments, n=3 and feature vectors F₁(p), F₂(p), and F₃(p) are associated with spatial resolutions of 128\hat{ }3, 64\hat{ }3, and 32\hat{ }3, respectively. As a second example, in some embodiments, n=4 and feature vectors F₁(p), F₂(p), F₃(p), and F₄(p) are associated with spatial resolutions of 128\hat{ }3, 64\hat{ }3, 32\hat{ }3, and 16\hat{ }3, respectively. Here, p denotes the points from the point cloud data.

At step 150, a 3D modeling machine learning procedure is applied to the plurality of feature vectors to determine a 3D model of the object. In some embodiments, the 3D modeling machine learning procedure comprises a NN, a CNN, a 3D CNN, or an MLP. In some embodiments, the 3D modeling machine learning procedure comprises a neural implicit representation procedure. In some embodiments, the plurality of feature vectors are concatenated to form a concatenated feature vector and the 3D modeling machine learning procedure is applied to the concatenated feature vector. As a first example, in some embodiments, n=3 and feature vectors F₁(p), F₂(p), and F₃(p) are associated with spatial resolutions of 128\hat{ }3, 64\hat{ }3, and 32\hat{ }3, respectively. The feature vectors are concatenated to form a concatenated feature vector F(p)=F₁(p)F₂(p)F₃(p). The concatenated feature vector is then passed to the 3D modeling machine learning procedure and, which outputs a 3D model s=f (F(p)) of the object. As a second example, in some embodiments, =4 and feature vectors F₁(p), F₂(p), F₃(p), and F₄(p) are associated with spatial resolutions of 128\hat{ }3, 64\hat{ }3, 32\hat{ }3, and 16\hat{ }3, respectively. The feature vectors are concatenated to form a concatenated feature vector F(p)=F₁(p)F₂(p)F₃(p)F₄(p). The concatenated feature vector is then passed to the 3D modeling machine learning procedure and, which outputs a 3D model s=f(F (p)) f (F(p)) of the object. In some embodiments, the 3D model of the object comprises a continuous shape representation of the object. In some embodiments, the continuous shape representation of the object comprises a set of occupancies associated with the object, a signed distance function associated with the object, or an unsigned distance function associated with the object.

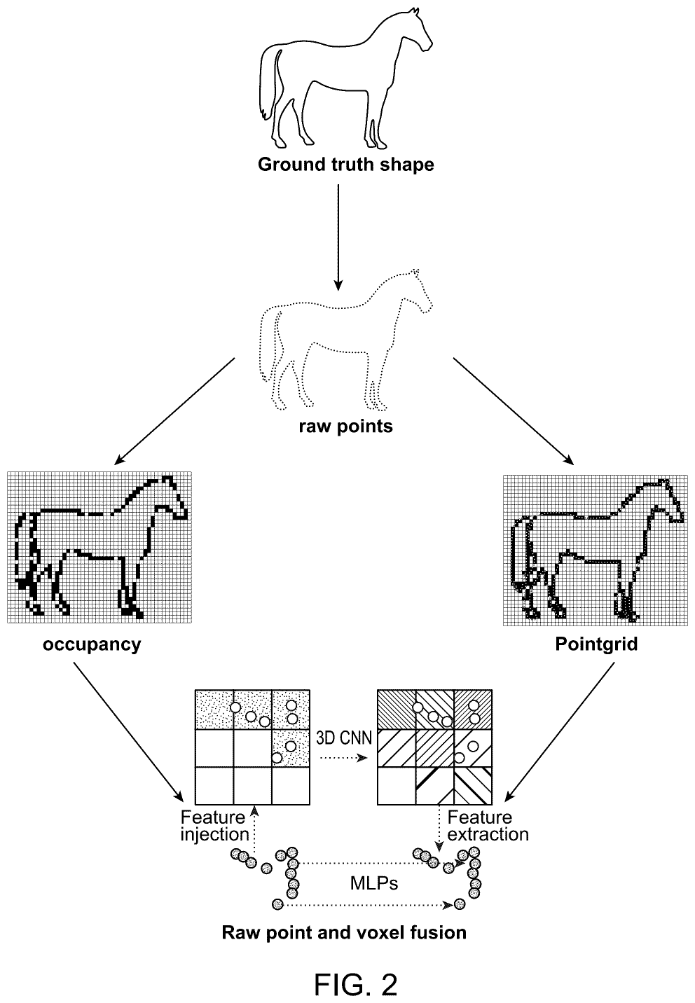

FIG. 2 depicts a first exemplary instantiation of the method 100 described herein with respect to FIG. 1. In FIG. 2, the method is implemented for a single spatial resolution, rather than the plurality of spatial resolutions described herein with respect to FIG. 1. As shown in FIG. 2, raw point cloud data is sampled from an object defined by a ground truth surface. The point cloud data is then voxelized as described herein with respect to step 120 of method 100 depicted in FIG. 1. In some embodiments, the point cloud data is voxelized based on an occupancy procedure, as described herein. In some embodiments, the point cloud data is voxelized based on a pointgrid procedure, as described herein. Point data is brought to volume data by injecting the point cloud data to the voxelized representation of the data. A 3D CNN is applied to extract a feature vector F₁ (p). The procedure obtains both context semantic information from convolution of the voxelized representation and detail geometric features from the point cloud data.

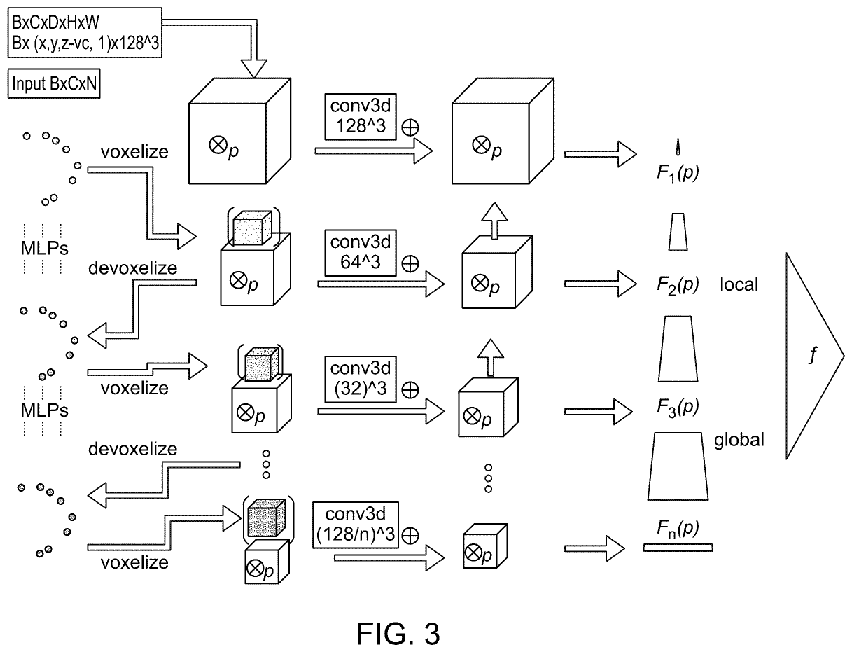

FIG. 3 depicts a second exemplary instantiation of the method 100 described herein with respect to FIG. 1. In FIG. 3, the method is implemented for n different spatial resolution. As shown in FIG. 3, point cloud data is used to extract a first feature vector F₁(p) at a 128\hat{ }3 spatial resolution. The point cloud data is then used to extract a second feature vector F₂(p) at a 64\hat{ }3 spatial resolution. This procedure continues for third feature vector F₃(p) at a 32\hat{ }3 spatial resolution and on until reaching an n-th feature vector Fₙ(p) at a (128/n)\hat{ }3 spatial resolution. A concatenated feature vector F (p)=F₁(p)F₂(p)F₃(p) . . . Fₙ(p) is assembled and a 3D modeling machine learning procedure f is applied to obtain a 3D model s=f (F(p)).

The point-voxel machine learning procedure may be trained using a training data sets comprising input point cloud data x and corresponding surface mesh data s. Points p are sampled from the point cloud data and their ground truth distance DF (p, s) to the surface is computed. A point-voxel machine learning procedure is learned by any of the following regression loss functions during training with a training dataset:

$${L}_{B} ( w ) = \frac{1}{\vert B \vert} {\sum }_{i = 1}^{\vert B \vert} {\sum }_{j = 1}^{K} ( trunc ( {f}^{w} ( {p}_{i}^{j} ) , δ ) - trunc ( \vert DF ( {p}_{i}^{j} , {s}_{i} ) \vert , δ ) \qquad ( 1 )$$

$${L}_{B} ( w ) = \frac{1}{\vert B \vert} {\sum }_{i = 1}^{\vert B \vert} {\sum }_{j = 1}^{K} ( {f}^{w} ( {p}_{i}^{j} ) - DF ( {p}_{i}^{j} , {s}_{i} ) ) \qquad ( 2 )$$

$${L}_{B} ( w ) = \frac{1}{\vert B \vert} {\sum }_{i = 1}^{\vert B \vert} {\sum }_{j = 1}^{K} CE ( {f}^{w} ( {p}_{i}^{j} ) , DF ( {p}_{i}^{j} , {s}_{i} ) ) \qquad ( 3 )$$

Here, Equation (1) is used for unsigned distance field learning, Equation (2) is used for signed distance field learning, and Equation (3) is used for occupancy learning. CE is the cross-entropy loss, B is the mini-batch size, and f^{w}=f (S(g(p)), A(g(p), p−Pₙ)) is the point-voxel machine learning procedure consisting of encoder g, predictor S, and adaptive weighting A. The truncation threshold is given by δ.

Additionally, systems are disclosed that can be used to perform the method 100 of FIG. 1 or any one or more of steps 110, 120, 130, 140, and 150. In some embodiments, the systems comprise one or more processors and memory coupled to the one or more processors. In some embodiments, the one or more processors are configured to implement one or more steps of method 100. In some embodiments, the memory is configured to provide the one or more processors with instructions corresponding to the operations of method 100. In some embodiments, the instructions are embodied in a tangible computer readable storage medium.

FIG. 4 is a block diagram of a computer system 400 used in some embodiments to perform all or portions of method 100 described herein (such as steps 110, 120, 130, 140, and/or 150 of method 100 as described herein with respect to FIG. 1). In some embodiments, the computer system may be utilized as a component in systems for performing the method of FIG. 1. FIG. 4 illustrates one embodiment of a general purpose computer system. Other computer system architectures and configurations can be used for carrying out the processing of the present invention. Computer system 400, made up of various subsystems described below, includes at least one microprocessor subsystem 401. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 400. Using instructions retrieved from memory 404, the microprocessor subsystem controls the reception and manipulation of input data, and the output and display of data on output devices.

The microprocessor subsystem 401 is coupled bi-directionally with memory 404, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 404 may include any suitable computer-readable storage media, described below, depending on whether, for example, data access needs to be bi-directional or uni-directional. The microprocessor subsystem 401 can also directly and very rapidly retrieve and store frequently needed data in a cache memory (not shown).

A removable mass storage device 405 provides additional data storage capacity for the computer system 400, and is coupled either bi-directionally (read/write) or uni-directionally (read only) to microprocessor subsystem 401. Storage 405 may also include computer-readable media such as magnetic tape, flash memory, signals embodied on a carrier wave, PC-CARDS, portable mass storage devices, holographic storage devices, and other storage devices. A fixed mass storage 409 can also provide additional data storage capacity. The most common example of mass storage 409 is a hard disk drive. Mass storage 405 and 409 generally store additional programming instructions, data, and the like that typically are not in active use by the processing subsystem. It will be appreciated that the information retained within mass storage 405 and 409 may be incorporated, if needed, in standard fashion as part of primary storage 404 (e.g., RAM) as virtual memory.

In addition to providing processing subsystem 401 access to storage subsystems, bus 406 can be used to provide access other subsystems and devices as well. In the described embodiment, these can include a display monitor 408, a network interface 407, a keyboard 402, and a pointing device 403, as well as an auxiliary input/output device interface, a sound card, speakers, and other subsystems as needed. The pointing device 403 may be a mouse, stylus, track ball, or tablet, and is useful for interacting with a graphical user interface.

The network interface 407 allows the processing subsystem 401 to be coupled to another computer, computer network, or telecommunications network using a network connection as shown. Through the network interface 407, it is contemplated that the processing subsystem 401 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 401 can be used to connect the computer system 400 to an external network and transfer data according to standard protocols. That is, method embodiments of the present invention may execute solely upon processing subsystem 401, or may be performed across a network such as the Internet, intranet networks, or local area networks, in conjunction with a remote processing subsystem that shares a portion of the processing. Additional mass storage devices (not shown) may also be connected to processing subsystem 401 through network interface 407.

An auxiliary I/O device interface (not shown) can be used in conjunction with computer system 400. The auxiliary I/O device interface can include general and customized interfaces that allow the processing subsystem 401 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 4 is but an example of a computer system suitable for use with the invention. Other computer systems suitable for use with the invention may include additional or fewer subsystems. In addition, bus 406 is illustrative of any interconnection scheme serving to link the subsystems. Other computer architectures having different configurations of subsystems may also be utilized.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure.

### EXAMPLES

### Example 1: Comparison of the Methods Described Herein with Previous 3D Model Reconstruction Methods

The methods described herein were utilized to extract 3D models of a variety of objects contained in the shapenet database. The reconstructed 3D models were compared with those generated using a variety of other 3D model reconstruction methods described in previous works.

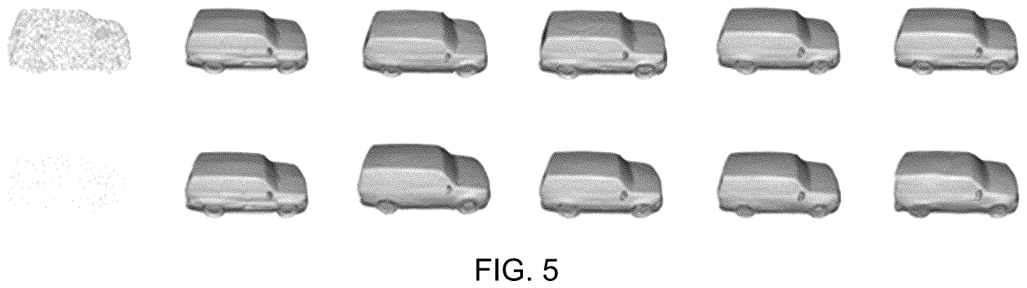

FIG. 5 depicts exemplary 3D model reconstructions of an automobile obtained using a variety of 3D model reconstruction methods. The upper 3D models were reconstructed using point cloud data comprising 3,000 points. The upper 3D models were reconstructed using point cloud data comprising 300 points. From left to right, the first column depicts the point cloud data, the second column depicts the ground truth surface of the object from which the point cloud data was obtained, the third column depicts the 3D model reconstructed using the IF-Net procedure, the fourth column depicts the 3D model reconstructed using the IF-Net+PVD procedure, the fifth column depicts the 3D model reconstructed using the NDF procedure, and the final column depicts the 3D model reconstructed using the methods described herein.

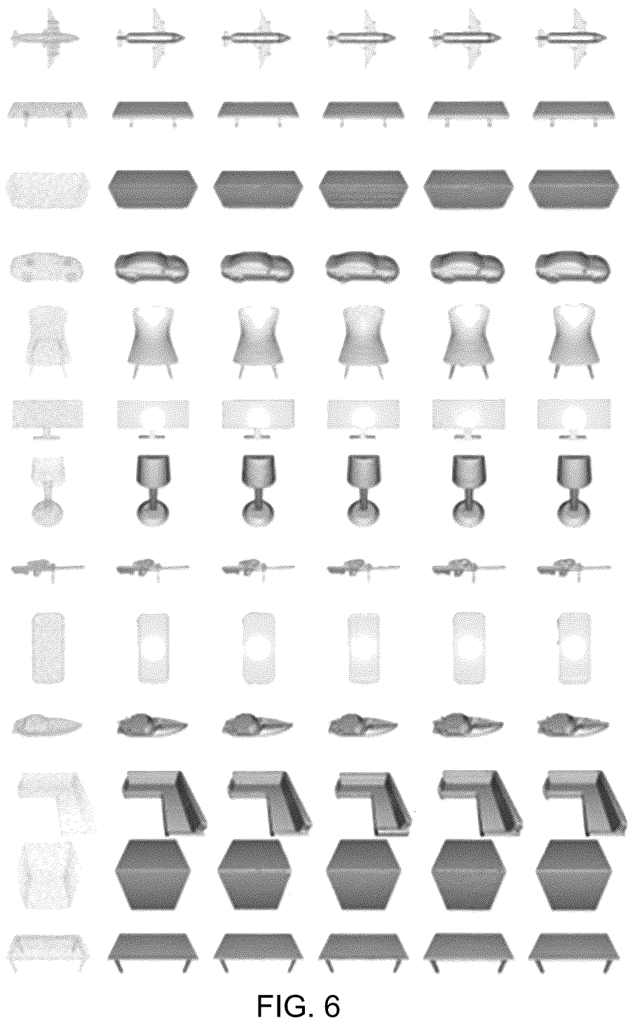

FIG. 6 depicts exemplary 3D model reconstructions of representative shapes from all classes of the shapenet dataset obtained using a variety of 3D model reconstruction methods. In all cases, the 3D models were reconstructed using point cloud data comprising 3,000 points. From left to right, the first column depicts the point cloud data, the second column depicts the ground truth surfaces of the object from which the point cloud data was obtained, the third column depicts the 3D models reconstructed using the IF-Net procedure, the fourth column depicts the 3D models reconstructed using the IF-Net+PVD procedure, the fifth column depicts the 3D models reconstructed using the NDF procedure, and the final column depicts the 3D models reconstructed using the methods described herein. As shown in FIG. 6, the methods described herein accurately reproduce the surfaces of all classes of objects contained in the shapenet database.

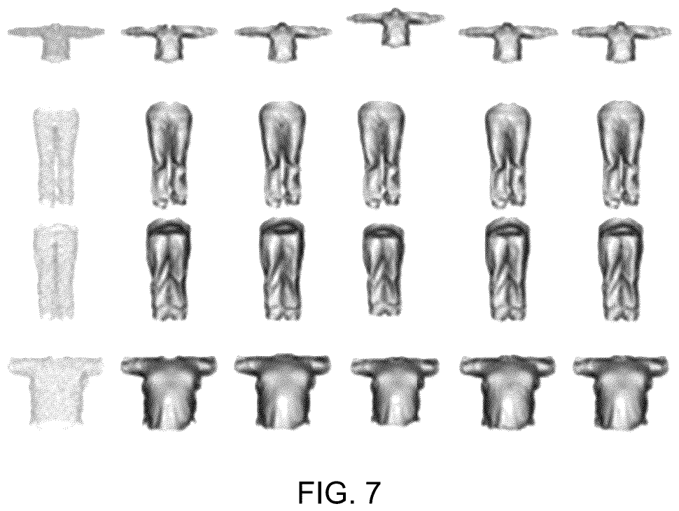

FIG. 7 depicts exemplary 3D model reconstructions of garments obtained using a variety of 3D model reconstruction methods. In all cases, the 3D models were reconstructed using point cloud data comprising 3,000 points. From left to right, the first column depicts the point cloud data, the second column depicts the ground truth surfaces of the object from which the point cloud data was obtained, the third column depicts the 3D models reconstructed using the IF-Net procedure, the fourth column depicts the 3D models reconstructed using the IF-Net+PVD procedure, the fifth column depicts the 3D models reconstructed using the NDF procedure, and the final column depicts the 3D models reconstructed using the methods described herein. As shown in FIG. 7, the methods described herein reproduce the surfaces of garments contained in the shapenet database more accurately than previous methods.

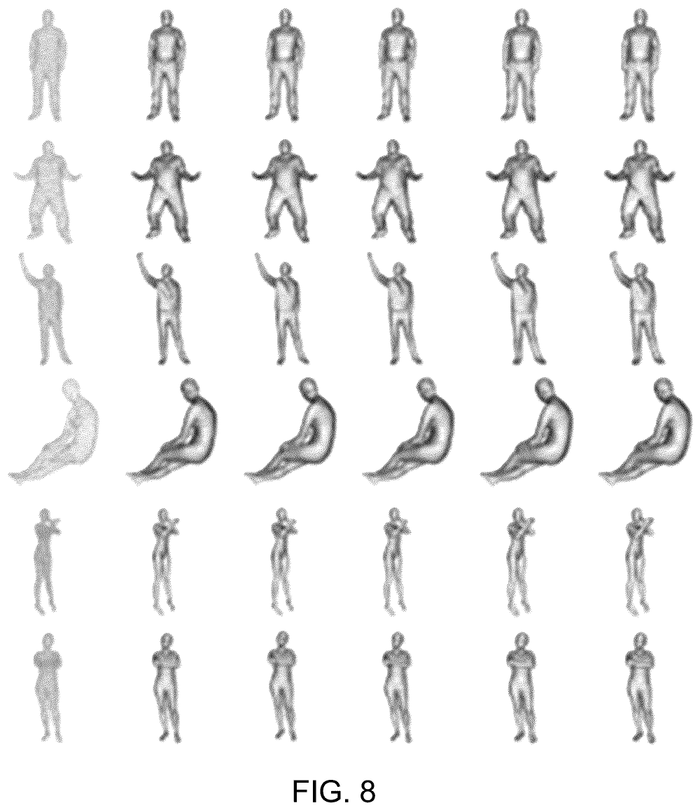

FIG. 8 depicts exemplary 3D model reconstructions of human bodies obtained using a variety of 3D model reconstruction methods. In all cases, the 3D models were reconstructed using point cloud data comprising 3,000 points. From left to right, the first column depicts the point cloud data, the second column depicts the ground truth surfaces of the object from which the point cloud data was obtained, the third column depicts the 3D models reconstructed using the IF-Net procedure, the fourth column depicts the 3D models reconstructed using the IF-Net+PVD procedure, the fifth column depicts the 3D models reconstructed using the NDF procedure, and the final column depicts the 3D models reconstructed using the methods described herein. As shown in FIG. 8, the methods described herein reproduce the surfaces of human bodies contained in the shapenet database more accurately than previous methods.

### RECITATION OF EMBODIMENTS

Embodiment 1. A method for forming a three-dimensional (3D) model of an object, comprising:
a. receiving point cloud data, the point cloud data comprising coordinates associated with a plurality of points located on or near a surface of an object;
b. voxelizing the point cloud data based on a predetermined spatial resolution to thereby form a voxelized representation of the point cloud data;
c. applying a point-voxel machine learning procedure to the voxelized representation and the point cloud data to thereby determine a feature vector associated with the spatial resolution;
d. repeating (b)-(c) for a plurality of spatial resolutions to thereby determine a plurality of feature vectors, each feature vector associated with a spatial resolution of the plurality of spatial resolutions; and
e. applying a 3D modeling machine learning procedure to the plurality of feature vectors to thereby determine a 3D model of the object.

Embodiment 2. The method of Embodiment 1, wherein the point cloud data is obtained using a 3D scanner, tomographic imaging scanner, or laser distance and ranging (LIDAR) scanner.

Embodiment 3. The method of Embodiment 1 or 2, wherein (b) comprises voxelizing the point cloud data based on an occupancy procedure or a pointgrid procedure.

Embodiment 4. The method of any one of Embodiments 1-3, wherein the point-voxel machine learning procedure comprises a neural network (NN), a convolutional NN (CNN), a 3D CNN, or a multi-layer perceptron (MLP).

Embodiment 5. The method of any one of Embodiments 1-4, wherein the point-voxel machine learning procedure comprises a neural implicit representation procedure.

Embodiment 6. The method of any one of Embodiments 1-5, wherein the 3D modeling machine learning procedure comprises an NN, a CNN, a 3D CNN, or an MLP.

Embodiment 7. The method of any one of Embodiments 1-6, wherein the 3D modeling machine learning procedure comprises a neural implicit representation procedure.

Embodiment 8. The method of any one of Embodiments 1-7, wherein (e) comprises concatenating the plurality of features vectors to thereby form a concatenated feature vector and applying the 3D modeling machine learning procedure to the concatenated feature vector.

Embodiment 9. The method of any one of Embodiments 1-8, wherein the 3D model of the object comprises a continuous shape representation of the object.

Embodiment 10. The method of Embodiment 9, wherein the continuous shape representation of the object comprises an unsigned distance function or signed distance function associated with the object.

Embodiment 11. A system for forming a three-dimensional (3D) model of an object, comprising a computing system configured to implement a method comprising:
a. receiving point cloud data, the point cloud data comprising coordinates associated with a plurality of points located on or near a surface of an object;
b. voxelizing the point cloud data based on a predetermined spatial resolution to thereby form a voxelized representation of the point cloud data;
c. applying a point-voxel machine learning procedure to the voxelized representation and the point cloud data to thereby determine a feature vector associated with the spatial resolution;
d. repeating (b)-(c) for a plurality of spatial resolutions to thereby determine a plurality of feature vectors, each feature vector associated with a spatial resolution of the plurality of spatial resolutions; and
e. applying a 3D modeling machine learning procedure to the plurality of feature vectors to thereby determine a 3D model of the object.

Embodiment 12. The system of Embodiment 11, wherein the point cloud data is obtained using a 3D scanner, tomographic imaging scanner, or laser distance and ranging (LIDAR) scanner.

Embodiment 13. The system of Embodiment 11 or 12, wherein (b) comprises voxelizing the point cloud data based on an occupancy procedure or a pointgrid procedure.

Embodiment 14. The system of any one of Embodiments 11-13, wherein the point-voxel machine learning procedure comprises a neural network (NN), a convolutional NN (CNN), a 3D CNN, or a multi-layer perceptron (MLP).

Embodiment 15. The system of any one of Embodiments 11-14, wherein the point-voxel machine learning procedure comprises a neural implicit representation procedure.

Embodiment 16. The system of any one of Embodiments 11-15, wherein the 3D modeling machine learning procedure comprises an NN, a CNN, a 3D CNN, or an MLP.

Embodiment 17. The system of any one of Embodiments 11-16, wherein the 3D modeling machine learning procedure comprises a neural implicit representation procedure.

Embodiment 18. The system of any one of Embodiments 11-17, wherein (e) comprises concatenating the plurality of features vectors to thereby form a concatenated feature vector and applying the 3D modeling machine learning procedure to the concatenated feature vector.

Embodiment 19. The system of any one of Embodiments 11-18, wherein the 3D model of the object comprises a continuous shape representation of the object.

Embodiment 20. The system of Embodiment 19, wherein the continuous shape representation of the object comprises an unsigned distance function or signed distance function associated with the object.

Embodiment 21. A non-transitory machine-readable storage medium configured to implement a method for forming a three-dimensional (3D) model of an object, the method comprising:
a. receiving point cloud data, the point cloud data comprising coordinates associated with a plurality of points located on or near a surface of an object;
b. voxelizing the point cloud data based on a predetermined spatial resolution to thereby form a voxelized representation of the point cloud data;
c. applying a point-voxel machine learning procedure to the voxelized representation and the point cloud data to thereby determine a feature vector associated with the spatial resolution;
d. repeating (b)-(c) for a plurality of spatial resolutions to thereby determine a plurality of feature vectors, each feature vector associated with a spatial resolution of the plurality of spatial resolutions; and
e. applying a 3D modeling machine learning procedure to the plurality of feature vectors to thereby determine a 3D model of the object.

Embodiment 22. The non-transitory machine-readable storage medium of Embodiment 21, wherein the point cloud data is obtained using a 3D scanner, tomographic imaging scanner, or laser distance and ranging (LIDAR) scanner.

Embodiment 23. The non-transitory machine-readable storage medium of Embodiment 21 or 22, wherein (b) comprises voxelizing the point cloud data based on an occupancy procedure or a pointgrid procedure.

Embodiment 24. The non-transitory machine-readable storage medium of any one of Embodiments 21-23, wherein the point-voxel machine learning procedure comprises a neural network (NN), a convolutional NN (CNN), a 3D CNN, or a multi-layer perceptron (MLP).

Embodiment 25. The non-transitory machine-readable storage medium of any one of Embodiments 21-24, wherein the point-voxel machine learning procedure comprises a neural implicit representation procedure.

Embodiment 26. The non-transitory machine-readable storage medium of any one of Embodiments 21-25, wherein the 3D modeling machine learning procedure comprises an NN, a CNN, a 3D CNN, or an MLP.

Embodiment 27. The non-transitory machine-readable storage medium of any one of Embodiments 21-26, wherein the 3D modeling machine learning procedure comprises a neural implicit representation procedure.

Embodiment 28. The non-transitory machine-readable storage medium of any one of Embodiments 21-27, wherein (e) comprises concatenating the plurality of features vectors to thereby form a concatenated feature vector and applying the 3D modeling machine learning procedure to the concatenated feature vector.

Embodiment 29. The non-transitory machine-readable storage medium of any one of Embodiments 21-28, wherein the 3D model of the object comprises a continuous shape representation of the object.

Embodiment 30. The non-transitory machine-readable storage medium of Embodiment 29, wherein the continuous shape representation of the object comprises an unsigned distance function or signed distance function associated with the object.

1. A method for forming a three-dimensional (3D) model of an object, comprising:
a. receiving point cloud data, the point cloud data comprising coordinates associated with a plurality of points located on or near a surface of an object;
b. voxelizing the point cloud data based on a predetermined spatial resolution to thereby form a voxelized representation of the point cloud data;
c. applying a point-voxel machine learning procedure to the voxelized representation and the point cloud data to thereby determine a feature vector associated with the spatial resolution;
d. repeating (b)-(c) for a plurality of spatial resolutions to thereby determine a plurality of feature vectors, each feature vector associated with a spatial resolution of the plurality of spatial resolutions; and
e. applying a 3D modeling machine learning procedure to the plurality of feature vectors to thereby determine a 3D model of the object.

2. The method of claim 1, wherein the point cloud data is obtained using a 3D scanner, tomographic imaging scanner, or laser distance and ranging (LIDAR) scanner.

3. The method of claim 1, wherein (b) comprises voxelizing the point cloud data based on an occupancy procedure or a pointgrid procedure.

4. The method of claim 1, wherein the point-voxel machine learning procedure comprises a neural network (NN), a convolutional NN (CNN), a 3D CNN, or a multi-layer perceptron (MLP).

5. The method of claim 1, wherein the point-voxel machine learning procedure comprises a neural implicit representation procedure.

6. The method of claim 1, wherein the 3D modeling machine learning procedure comprises an NN, a CNN, a 3D CNN, or an MLP.

7. The method of claim 1, wherein the 3D modeling machine learning procedure comprises a neural implicit representation procedure.

8. The method of claim 1, wherein (e) comprises concatenating the plurality of features vectors to thereby form a concatenated feature vector and applying the 3D modeling machine learning procedure to the concatenated feature vector.

9. The method of claim 1, wherein the 3D model of the object comprises a continuous shape representation of the object.

10. The method of claim 9, wherein the continuous shape representation of the object comprises an unsigned distance function or signed distance function associated with the object.

11. A system for forming a three-dimensional (3D) model of an object, comprising a computing system configured to implement a method comprising:
a. receiving point cloud data, the point cloud data comprising coordinates associated with a plurality of points located on or near a surface of an object;
b. voxelizing the point cloud data based on a predetermined spatial resolution to thereby form a voxelized representation of the point cloud data;
c. applying a point-voxel machine learning procedure to the voxelized representation and the point cloud data to thereby determine a feature vector associated with the spatial resolution;
d. repeating (b)-(c) for a plurality of spatial resolutions to thereby determine a plurality of feature vectors, each feature vector associated with a spatial resolution of the plurality of spatial resolutions; and
e. applying a 3D modeling machine learning procedure to the plurality of feature vectors to thereby determine a 3D model of the object.

12. The system of claim 11, wherein the point cloud data is obtained using a 3D scanner, tomographic imaging scanner, or laser distance and ranging (LIDAR) scanner.

13. The system of claim 11, wherein (b) comprises voxelizing the point cloud data based on an occupancy procedure or a pointgrid procedure.

14. The system of claim 11, wherein the point-voxel machine learning procedure comprises a neural network (NN), a convolutional NN (CNN), a 3D CNN, or a multi-layer perceptron (MLP).

15. The system of claim 11, wherein the point-voxel machine learning procedure comprises a neural implicit representation procedure.

16. The system of claim 11, wherein the 3D modeling machine learning procedure comprises an NN, a CNN, a 3D CNN, or an MLP.

17. The system of claim 11, wherein the 3D modeling machine learning procedure comprises a neural implicit representation procedure.

18. The system of claim 11, wherein (e) comprises concatenating the plurality of features vectors to thereby form a concatenated feature vector and applying the 3D modeling machine learning procedure to the concatenated feature vector.

19. The system of claim 11, wherein the 3D model of the object comprises a continuous shape representation of the object.

20. The system of claim 19, wherein the continuous shape representation of the object comprises an unsigned distance function or signed distance function associated with the object.
